(19) United States
(12) Patent Application Publication
(10) Pub. No.: US 2010/0141385 A1
(43) Pub. Date: Jun. 10, 2010

(54) HANDHELD ELECTRONIC DEVICE AND MOBILE RFID READER THEREOF

(75) Inventors: JUN-TING SHIAU, Hsinchu (TW); TA-YUNG LEE, Hsinchu (TW); JEN-HAO HSU, Hsinchu (TW); CHIA-CHIN YU, Hsinchu (TW)

Correspondence Address: APEX JURIS, PLLC, 12733 LAKE CITY WAY NORTHEAST, SEATTLE, WA, 98125, US

(73) Assignee: MITAC TECHNOLOGY CORP., Hsinchu (TW)

(21) Appl. No.: 12/330,849

(22) Filed: Dec. 9, 2008

(51) Int. Cl. H04B 7/00

(52) U.S. Cl. 340/10.1

(57) ABSTRACT

A handheld electronic device and mobile RFID (Radio Frequency Identification) reader equipped thereon allow a user to move to wherever necessary and sense RFID tag data of a target object. The mobile RFID reader includes a microprocessor, a memory unit connected to the microprocessor, a reader positioning unit, a RFID transceiver, a temporary data storage and a network interface. The reader positioning unit positions the location of the RFID reader to obtain reader location information of the RFID reader, and then the RFID transceiver receives a tag signal with tag ID (Identification) data from RFID tag. The reader location information and the tag ID data of the RFID tag are able to be stored optionally in the temporary data storage, and will be uploaded to a backend network sever whenever the RFID reader is connected to the backend network sever through its network interface.

### BACKGROUND OF THE INVENTION

1. Field of the Invention

The present invention relates to RFID (Radio Frequency Identification) applications, and more particularly to a handheld electronic device and a mobile RFID reader implemented thereon.

2. Related Art

A conventional RFID system mainly includes RFID tag(s), RFID Reader(s), and at least one backend computer host. RFID tag is a data storage component, while RFID reader is to access the data from the RFID tag or store another data into the RFID. After receiving tag signals of the RFID tag, the RFID reader will send the retrieved data to the backend computer host for further data processing.

There are two common types of RFID tag: “active” and “passive” RFID tags. Active RFID tag has a battery configured therewith to actively send data to the RFID reader whenever necessary; active RFID tag usually has a longer transmission distance with the power supported by the battery, and can have a bigger memory for data storage. Consequently, active RFID tag is more expensive. Passive RFID tag only has tiny sensing electricity generated from sensing the electric wave (radio frequency signal) of RFID reader by a sensing antenna configured on passive RFIG tag; such sensing electricity is only enough for passive RFID tag to send back a responsive tag signal with the stored data through its antenna to RFID reader. Therefore, passive RFID tag has shorter transmission distance. The advantages of passive RFID tag are: no need of additional battery, small size, cheep, long life and portability of digital data. Generally the sensing antenna is embedded inside the passive RFID tag, and is capable of sensing and generating radio frequency signals for transmitting data.

An automatic monitoring/protecting RFID system for campus security is proposed in the market. Active “Ultra High Frequency” RFID technology is applied to a campus security monitoring/protecting mechanism. Active RFID tags are provided and carried by students. When a student passes a security zone with preset RFID readers as positioning devices, the active RFID tag will receive driving signal(s) from the RFID readers. The active RFID tag will then send its data to the RFID reader. The data of the active RFID tag will be further sent to a management server for integration. Afterwards, the management server will send these integrated data to an application server. The application server will then transmit the integrated data to students, their parents or centralized campus management. Specific messages regarding the student's presence in campus, absence without permission, bursting in a security zone or detention in a campus bus and etc., will be sent to mobile phones and computers of relevant parties for notice purposes

However, when disposing RFID readers for building up a security zone, some specific areas might have spatial or geography environmental problems, which results in difficulties of configuring the RFID readers or poor receipt/transmission performance of radio frequency signals.

### SUMMARY OF THE INVENTION

To solve the aforesaid problems of the prior art, the present invention provides a mobile RFID reader equipped thereof. The mobile RFID reader positions the location of it and receives tag ID data of a RFID tag, and then upload the two informations to a backend network sever. The present invention also provides a handheld electronic device equipped with a mobile RFID reader, such as integrating a RFID reader in a PDA or a SMARTPHONE, so as to make the handheld electronic device capable of providing functions of a mobile RFID reader.

In one aspect of the present invention, the mobile RFID reader includes a microprocessor, a memory unit connected to the microprocessor, a reader positioning unit, a RFID transceiver, a temporary data storage and a network interface. The reader positioning unit positions the location of the RFID reader to obtain reader location information of the RFID reader, and then the RFID transceiver receives a tag signal with tag ID (Identification) data from RFID tag. The reader location information and the tag ID data of the RFID tag are able to be stored optionally in the temporary data storage, and will be uploaded to a backend network sever whenever the RFID reader is connected to the backend network sever through its network interface.

By means of the technical solutions of the present invention, the difficulties of configuring the RFID readers or poor receipt/transmission performance of radio frequency signals in the prior art may now be resolved. The present invention is capable of mobile sensing for certain targets; meanwhile, the present invention does not affected by the linking status between the backend network sever. In an offline connection, relevant information may be stored in a temporary data storage, and then wait until connected online with the backend network sever. The present invention provides extraordinary conveniences and flexibilities. And therefore the present invention reduces the difficulties of establishing a security zone and decreases the cost to dispose as many RFID readers for every corner within the security zone.

Moreover, when the mobile RFID reader is integrated in a handheld electronic device, aside from the advantages above, the RFID function will be more suitable for the current functions of the handheld electronic device, such as wireless communicating through the communication module, or data management tools integrated in a PDA, thereby raises the functions of the handheld electronic device.

These and other features, aspects, and advantages of the present invention will become better understood with reference to the following description and appended claims. It is to be understood that both the foregoing general description and the following detailed description are examples, and are intended to provide further explanation of the invention as claimed.

### BRIEF DESCRIPTION OF THE DRAWINGS

The present invention will become more fully understood from the detailed description given herein below for illustration only, and thus is not limitative of the present invention, and wherein:

FIG. 1 is an explanatory block diagram of a RFID system according to the present invention;

FIG. 2 is an explanatory block diagram of a first embodiment according to the present invention;

FIG. 3 is an operation flowchart of the first embodiment according to the present invention;

FIG. 4 is an explanatory block diagram of a second embodiment according to the present invention;

FIG. 5 is an explanatory block diagram of a third embodiment according to the present invention;

FIG. 6 is an explanatory block diagram of a fourth embodiment according to the present invention;

FIG. 7 is an explanatory block diagram of a fifth embodiment according to the present invention; and

FIG. 8 is an explanatory block diagram of a handheld electronic device that is equipped with a mobile RFID reader according to a sixth embodiment of the present invention.

### DETAILED DESCRIPTION OF THE INVENTION

Reference will now be made in detail to the present preferred embodiments of the invention, examples of which are illustrated in the accompanying drawings. Wherever possible, the same reference numbers are used in the drawings and the description refers to the same or the like parts.

Basically in the present invention, the location of the mobile RFID reader (or the handheld electronic device) will be positioned first to obtain the reader location information; and then both the reader location information of the mobile RFID reader (or the handheld electronic device) and the tag ID data of a target RFID tag will be used as a basis to obtain the location information of the target RFID tag. RSSI (Received Signal Strength Indication) is possible to be performed to position the location of the target RFID tag according to the signal intensity of the RFID tag signal transmitted from the target RFID tag.

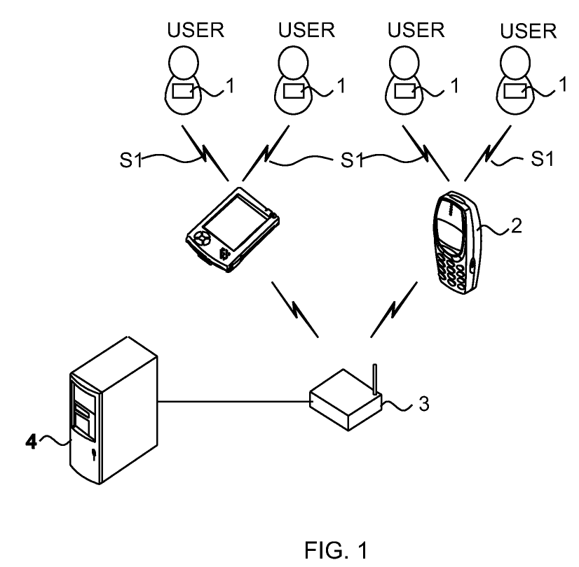

FIG. 1 is an explanatory block diagram of a RFID (Radio Frequency Identification) system according to the present invention. As shown in the drawing, each of multiple users wears a RFID tag 1. The RFID tag 1 is capable of sending a tag signal S1; the tag signal S1 may be received by a mobile RFID reader 2, read out with data carried in the tag signal S1 from the RFID tag 1, and then send the data to a backend network sever by connecting the backend network sever 4 through a network connection device (such as a network gateway) 3.

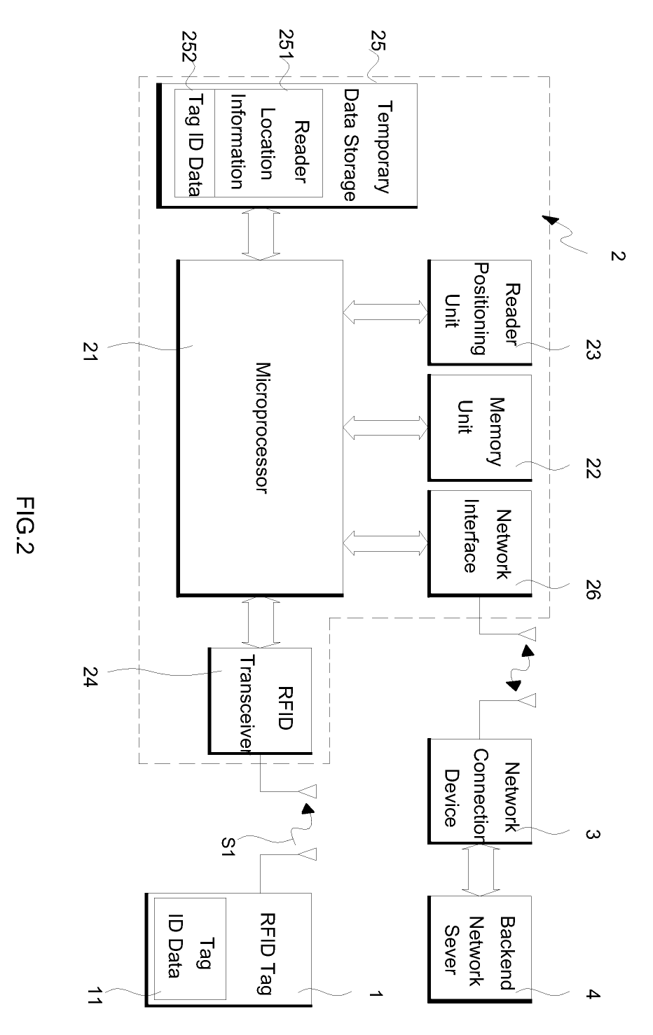

Refer to FIG. 2, an explanatory block diagram of a first embodiment according to the present invention. As showing in the drawing, a mobile RFID reader 2 includes a microprocessor 21, a memory unit 22 connected to the microprocessor 21, a reader positioning unit 23, a RFID transceiver 24, a temporary data storage 25 and a network interface 26. The microprocessor 21 connects with the memory unit 22, the reader positioning unit 23, the temporary data storage 25 and the network interface 26. Connection in the present invention is defined as connecting through communication buses, circuits, electrical traces, cables; wirely or wirelessly. The reader positioning unit 23 positions the location of the mobile RFID reader 2 and obtains reader location information 251, and then stores the reader location information 251 in the temporary data storage 25. The RFID transceiver 24 receives the tag signal S1 from the RFID tag 1 (the RFID transceiver 24 would also transmits query signals if the RFID tag 1 is a passive tag). The tag signal S1 includes tag ID (Identification) data 11 of the RFID tag 1; the tag ID data 11 may be stored in the temporary data storage 25. The network interface 26 allows the mobile RFID reader 2 to connect with a backend network sever 4 through a network connection device 3 (such as a network gateway); yet the network connection device 3 is not essential to connect to the backend network server 4. The mobile RFID reader 2 may connect with the backend network server 4 through the network interface 26 whenever the network interface 26 and the backend network server 4 are both in online connection with a network.

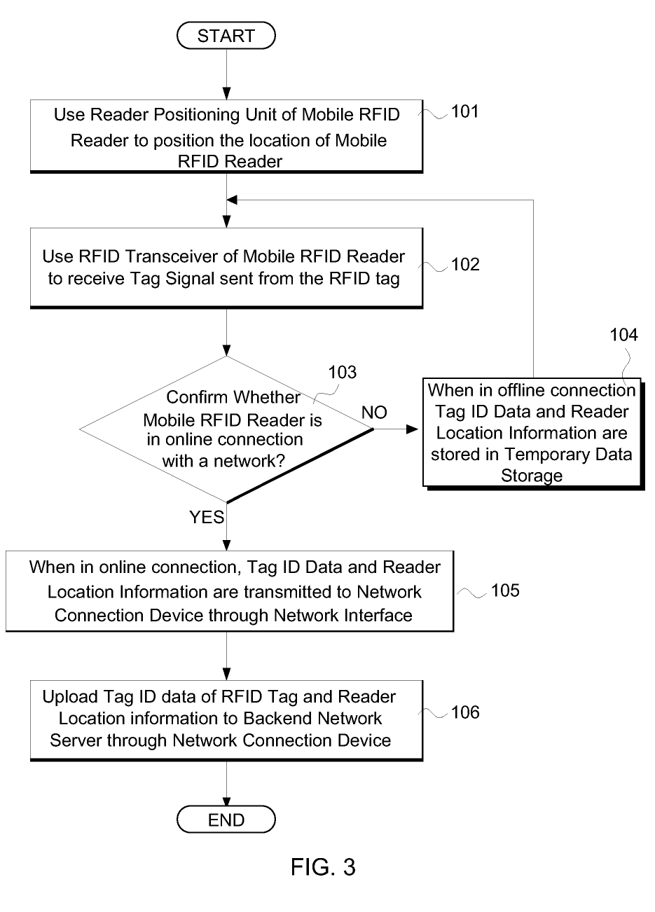

Refer to FIG. 3, an operation flowchart of the first embodiment according to the present invention. When in FIG. 2 the mobile RFID reader 2 is located in an area with at least one RFID tag 1 present in the surroundings, the reader positioning unit 23 configured in the mobile RFID reader 2 will first position the location of the mobile RFID reader 2 itself (Step 101), and stores the obtained reader location information 251 in the temporary data storage 25.

Next, the RFID transceiver 24 of the mobile RFID reader 2 will receive a tag signal S1 sent from the RFID tag 1 (Step 102) and obtain the tag ID data carried within the tag signal S1. If the RFID tag 1 is a passive tag, the RFID transceiver 24 will need to send a query signal to the RFID tag 1 first, and then the RFID tag 1 will response with the tag signal S1. If the RFID tag 1 is an active tag, the RFID tag 1 will be able to constantly send the tag signal S1 for a preset time interval.

Afterwards, confirm whether the network interface 26 of the mobile RFID reader 2 is in online connection with a network (such as internet, intranet or private network and etc.) (Step 103) When the mobile RFID reader 2 is in offline connection with the network, store the tag ID data 11 of the RFID tag 1 in the temporary data storage 25 (Step 104) (as the tag ID data 252).

On the contrary, when the mobile RFID reader 2 is in online connection with the network, the reader location information 251 and the tag ID data 252 stored in the temporary data storage 25 will be transmitted to the network connection device 3 through the network interface 26 (Step 105).

Finally, through the network connection device 3, transmit the tag ID data 252 and the reader location information 251 to the backend network sever 4 (Step 106). In a practical embodiment, the network connection device 3 (such as a network gateway) is not absolutely necessary for the mobile RFID reader 2 to connect with the backend network server 4, so Steps 105 and 106 is possible to combine together without the network connection device 3 operating as the function of a network hub. Namely, the mobile RFID reader 2 will be able to directly connect with the backend network server 4 through the network interface 26.

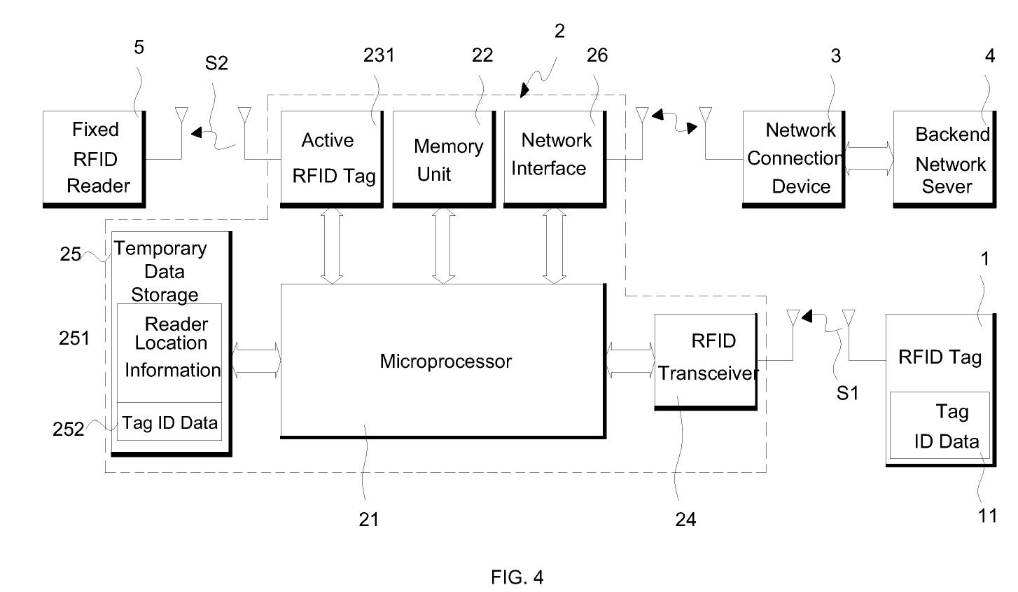

Please refer to FIG. 4, which is an explanatory block diagram of a second embodiment according to the present invention. As shown in the drawing, the present embodiment has similar system architecture as the first embodiment in FIG. 2. The major difference is, in FIG. 4 the microprocessor 21 of the present embodiment connects with an active RFID tag 231 to realize the reader positioning unit 23 (refer to FIG. 2). The positioning method in FIG. 3 is that the active RFID tag 231 actively transmits a RFID tag signal S2 to a fixed RFID reader 5 predisposing at a designated position, and then a positioning method such as RSSI (Received Signal Strength Indication) is performed in the fixed RFID reader 5 or the backend network sever 4 to position the location of mobile RFID reader 2 according to the signal intensity of the RFID tag signal S2 transmitted from the active RFID tag 231. Therefore, the backend network sever 4 or the fixed RFID reader 5 will be possible to obtain the reader location information 251 of the mobile RFID reader 2. The reader location information 251 obtained this way could be a set of “location row data” including “location information of the fixed RFID reader 5” and “signal intensity of the RFID tag signal S2 sent from the mobile RFID reader 2”, or a processed location information based on the former two row data. Furthermore, the active RFID tag 231 of the present embodiment may be replaced by a passive RFID tag, and the RFID tag signal S2 will still be generated passively by the passive RFID tag. No matter the reader positioning unit is realized by an active or passive RFID tag, the reader location information 251 will be able to transmit to the backend network sever 4. The fixed RFID reader 5 may be in online connection with the backend network sever 4 so as to transmit the obtained reader location information 251 of the mobile RFID reader 2 directly. As mentioned above, the set of location row data used as the reader location information 251, may be sent from the fixed RFID reader 5 to the backend network sever 4. The backend network sever 4 (or the fixed RFID reader 5 itself) may bases on the set of location row data to obtain a processed location information as the reader location information 251. On the other hand, the mobile RFID reader 2 is possible to access the reader location information 251 obtained by the fixed RFID reader 5, and then stores in the temporary data storage 25 as well. Other operation principles and operation procedures are the same as the first embodiment, so the relevant details are not further repeated herein.

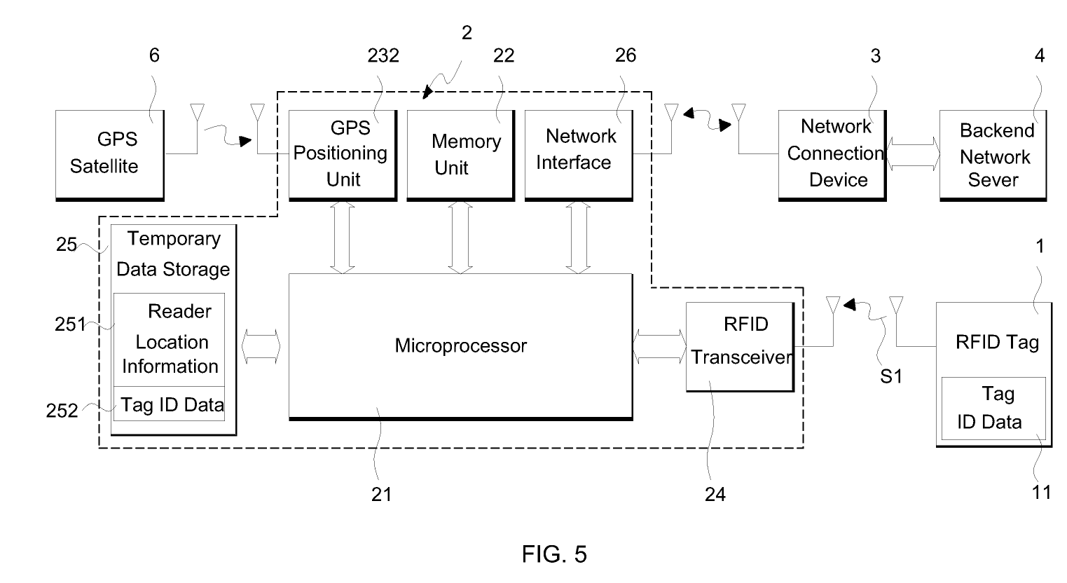

Please refer to FIG. 5, which is an explanatory block diagram of a third embodiment according to the present invention. As shown in the drawing, the present embodiment has similar system architecture as the first embodiment in FIG. 2. The major difference is, in FIG. 5 the microprocessor 21 of the present embodiment connects with a GPS positioning unit 232 to realize the reader positioning unit 23 (refer to FIG. 2). The present embodiment uses GPS (Global Positioning System) positioning technology, namely uses the GPS positioning unit 232 to receive satellite signal(s) transmitted from GPS satellite(s) 6, thereby position and obtain the location of the mobile RFID reader 2. Other operation principles and operation procedures are the same as the first embodiment, so the relevant details are not further repeated herein.

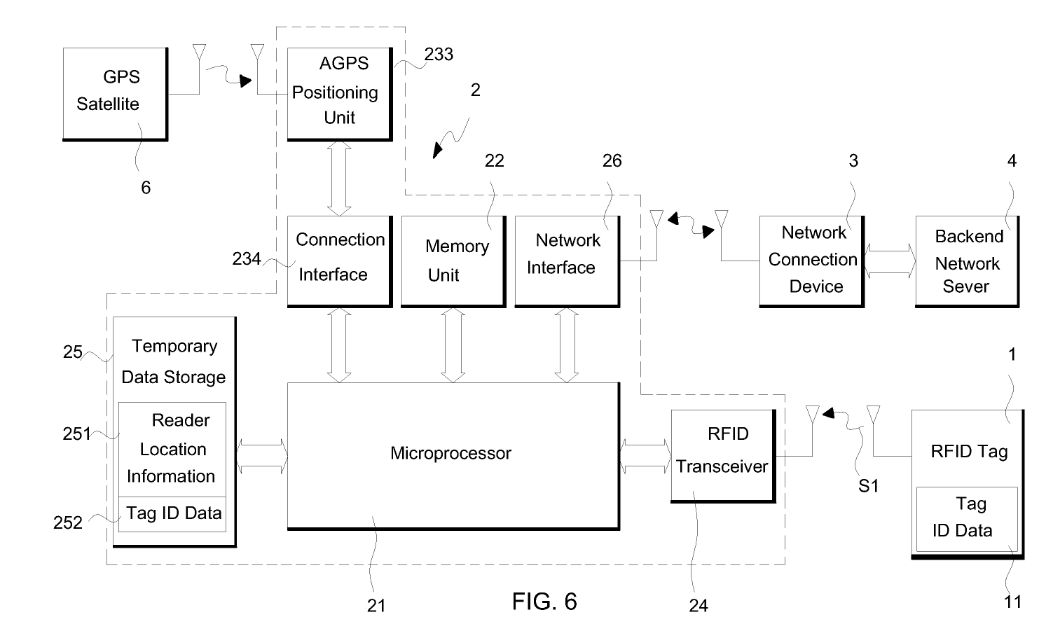

Please refer to FIG. 6, which is an explanatory block diagram of a fourth embodiment according to the present invention. As shown in the drawing, the present embodiment basically has similar system architecture as the first embodiment in FIG. 2. Similar to the second and the third embodiments, the major difference is that the present embodiment uses an AGPS (Assisted Global Positioning System) positioning unit 233 to realize the reader positioning unit 23 (refer to FIG. 2). The AGPS positioning unit 233 connects with the microprocessor 21 through a connection interface 234. The connection interface 234 may include a system bus and/or a bus bridge chip. Generally in a cell mobile communication system, an AGPS system will collaborate with an auxiliary positioning server (such as a mobile phone positioning server) to share the positioning tasks. The calculation tasks for positioning will be performed by the auxiliary positioning server; the auxiliary positioning server will assist the AGPS positioning unit 233 to complete the distance-measuring and positioning tasks for the mobile RFID reader 2.

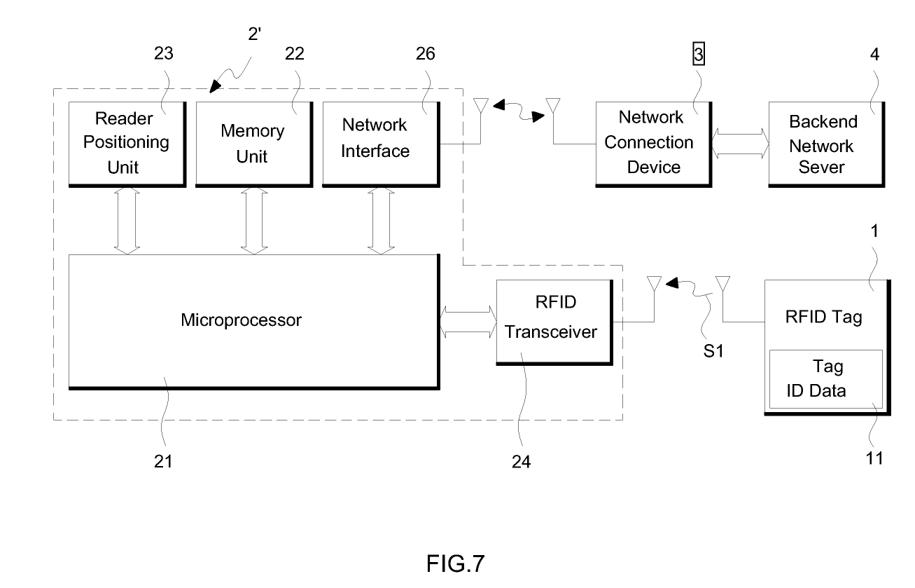

Please refer to FIG. 7, which is an explanatory block diagram of a fifth embodiment according to the present invention. In the present embodiment, the system architecture is similar to the first embodiment. The major difference is that the mobile RFID reader 2 does not have the temporary data storage 25 in FIG. 2, so the mobile RFID reader 2 is not able to temporarily store the reader location information 251 of the mobile RFID reader 2 when the mobile RFID reader 2 is in offline connection with the network (namely disconnecting with the backend network sever 4). In actual application, as long as the mobile RFID reader 2 is constantly in online connection with the network wirely/wirelessly, the location data received from the RFID tag 1 will be transmitted/uploaded to the backend network sever 4 through the network interface 26 and the network connection device 3 or through the network interface 26 solely.

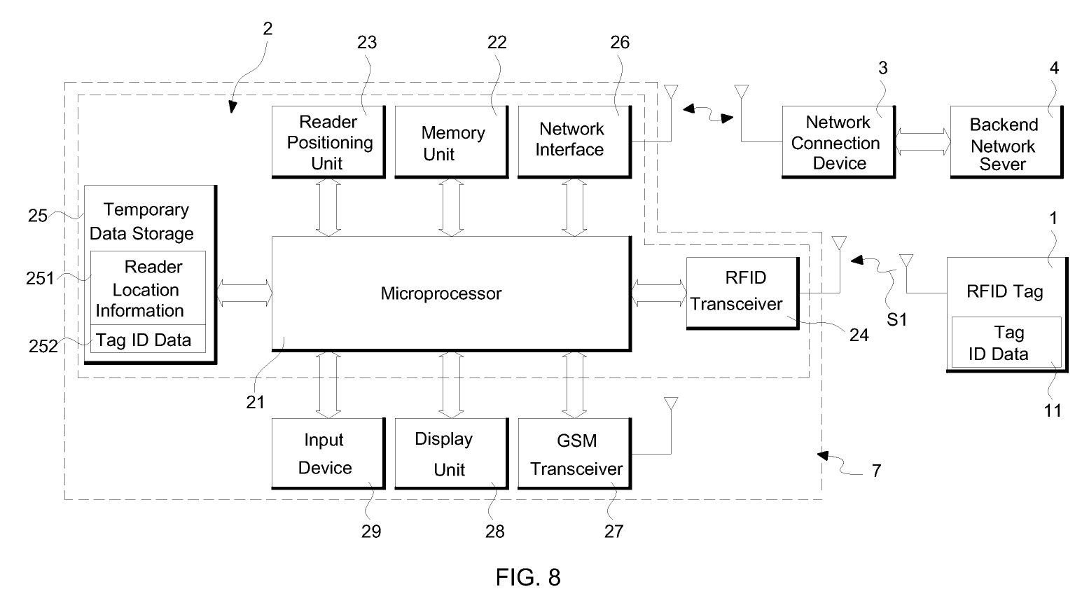

Please refer to FIG. 8, which is an explanatory block diagram of a handheld electronic device that is equipped with a mobile RFID reader according to a sixth embodiment of the present invention. In the present embodiment the mobile RFID reader 2 combines with a handheld electronic device 7 (for example a mobile phone or PDA (Personal Digital Assistant)). As shown in the drawing, the mobile RFID reader 2 has similar system architecture as the first embodiment. The microprocessor 21 operates as the processor of the handheld electronic device 7; except those components of the mobile RFID reader 2, the microprocessor 21 further connects with a GSM (Global System for Mobile Communications) transceiver (or other wireless communication module) 27, a display unit 28 and a input device 29, so as to provide functions and operate as a handheld electronic device 7. The input device 29 may be used to input commands; images will be displayed on the display unit 28; meanwhile the GSM transceiver 27 performs mobile communications, plus the mobile RFID reader 2 provides RFID functions for the handheld electronic device 7. The mobile RFID reader 2 disclosed in the aforesaid embodiments are all practical when implemented with the handheld electronic device 7.

Additional advantages and modifications will readily occur to those proficient in the relevant fields. The invention in its broader aspects is therefore not limited to the specific details and representative embodiments shown and described herein. Accordingly, various modifications may be made without departing from the spirit or scope of the general inventive concept as defined by the appended claims and their equivalents.

What is claimed is:

1. A mobile RFID (Radio Frequency Identification) reader to sense a tag signal sent from at least one RFID tag, the mobile RFID reader comprising:
a microprocessor;
a memory unit connected with the microprocessor;
a reader positioning unit, connected with the microprocessor to position the location of the RFID reader and obtain reader location information of the RFID reader;
a RFID transceiver, connected with the microprocessor to receive the tag signal sent from the RFID tag, the tag signal having tag ID (Identification) data of the RFID tag;
a temporary data storage, connected with the microprocessor;
a network interface, connected with the microprocessor to make the mobile RFID reader in online connection with a backend network sever;
wherein the reader location information of the RFID reader and the received tag ID data of the RFID tag are stored in the temporary data storage when the network interface of the RFID reader is in offline connection with the backend network sever;
wherein the reader location information and the tag ID data are transmitted to the backend network sever through the network interface when the network interface of the RFID reader is in online connection with the backend network sever.

2. The mobile RFID reader as claimed in claim 1, wherein the reader positioning unit is selected from the group consisting of a RFID tag, a GPS (Global Positioning System) positioning unit and a AGPS (Assisted Global Positioning System) positioning unit.

3. The mobile RFID reader as claimed in claim 1 further comprising a network connection device connected between the network interface and the backend network server, the network connection device comprising a network gateway.

4. The mobile RFID reader as claimed in claim 1, wherein the RFID tag is an active RFID tag.

5. The mobile RFID reader as claimed in claim 1, wherein the RFID tag is a passive RFID tag.

6. A mobile RFID (Radio Frequency Identification) reader to sense a tag signal sent from at least one RFID tag, the mobile RFID reader comprising:
a microprocessor;
a memory unit connected with the microprocessor;
a reader positioning unit, connected with the microprocessor to position the location of the RFID reader and obtain reader location information of the RFID reader;
a RFID transceiver, connected with the microprocessor to receive the tag signal sent from the RFID tag, the tag signal having tag ID (Identification) data of the RFID tag;
a network interface, connected with the microprocessor to make the mobile RFID reader in online connection with a backend network sever;
wherein the reader location information and the tag ID data are transmitted to the backend network sever through the network interface.

7. The mobile RFID reader as claimed in claim 6 further comprising a temporary data storage connected with the microprocessor.

8. The mobile RFID reader as claimed in claim 7, wherein the reader location information of the RFID reader and the received tag ID data of the RFID tag are stored in the temporary data storage when the network interface of the RFID reader is in offline connection with the backend network sever.

9. The mobile RFID reader as claimed in claim 7, wherein the reader location information and the tag ID data are transmitted to the backend network sever through the network interface only when the network interface of the RFID reader is in online connection with the backend network sever.

10. The mobile RFID reader as claimed in claim 6, wherein the reader positioning unit is selected from the group consisting of a RFID tag, a GPS (Global Positioning System) positioning unit and a AGPS (Assisted Global Positioning System) positioning unit.

11. The mobile RFID reader as claimed in claim 6 further comprising a network connection device connected between the network interface and the backend network server, the network connection device comprising a network gateway.

12. The mobile RFID reader as claimed in claim 6, wherein the RFID tag is an active RFID tag.

13. The mobile RFID reader as claimed in claim 6, wherein the RFID tag is a passive RFID tag.

14. A handheld electronic device equipped with a mobile RFID reader to sense a tag signal sent from at least one RFID tag, the handheld electronic device comprising:
a microprocessor;
a memory unit connected with the microprocessor;
a display unit, connected with the microprocessor to display images;
an input unit, connected with the microprocessor to input commands;
a communication module, connected with the microprocessor to perform mobile communication for the handheld electronic device;
a reader positioning unit, connected with the microprocessor to position the location of the RFID reader and obtain reader location information of the RFID reader;
a RFID transceiver, connected with the microprocessor to receive the tag signal sent from the RFID tag, the tag signal having tag ID (Identification) data of the RFID tag;
a network interface, connected with the microprocessor to make the mobile RFID reader in online connection with a backend network sever;
wherein the reader location information and the tag ID data are transmitted to the backend network sever through the network interface when the network interface of the RFID reader is in online connection with the backend network sever.

15. The mobile RFID reader as claimed in claim 14 further comprising a temporary data storage connected with the microprocessor.

16. The mobile RFID reader as claimed in claim 15, wherein the reader location information of the RFID reader and the received tag ID data of the RFID tag are stored in the temporary data storage when the network interface of the RFID reader is in offline connection with the backend network sever.

17. The handheld electronic device as claimed in claim 14, wherein the reader positioning unit is selected from the group consisting of a RFID tag, a GPS (Global Positioning System) positioning unit and a AGPS (Assisted Global Positioning System) positioning unit.

18. The handheld electronic device as claimed in claim 14 further comprising a network connection device connected between the network interface and the backend network server, the network connection device comprising a network gateway.

19. The handheld electronic device as claimed in claim 14, wherein the RFID tag is an active RFID tag.

20. The handheld electronic device as claimed in claim 14, wherein the RFID tag is a passive RFID tag.
